(19) United States
(12) Patent Application Publication
(10) Pub. No.: US 2023/0412541 A1
(43) Pub. Date: Dec. 21, 2023

(54) SYSTEM AND METHOD FOR PROVIDING EMOTIONAL INTELLIGENCE INSIGHT

(71) Applicant: Humantelligence Inc., Miami Beach, FL (US)

(72) Inventors: Juan Luis Betancourt, Coral Gables, FL (US); Marc LaCarrubba, Warren, NJ (US)

(21) Appl. No.: 17/879,678

(22) Filed: Aug. 2, 2022

Related U.S. Application Data
(60) Provisional application No. 63/228,313, filed on Aug. 2, 2021.

(51) Int. Cl. H04L 51/063; A61B 5/16

(52) U.S. Cl. CPC H04L 51/063; A61B 5/165

(57) ABSTRACT

A system and method for providing emotional intelligence insight in communication platforms including a software program operative on a user device, with the software program configured to reference a psychometric profile corresponding to at least one recipient of a communication to be sent by a user via the communication platform, and the software program configured to display to the user at least one recommendation for communication with the at least one recipient.

### CLAIM OF PRIORITY

The present application is based on, and a claim of priority is made under 35 U.S.C. Section 119(e) to a provisional patent application that is currently pending in the U.S. Patent and Trademark Office, namely, that having Ser. No. 63/228,313 and a filing date of Aug. 2, 2021, and which is incorporated herein by reference.

### FIELD OF THE INVENTION

The present invention relates generally to a system for providing emotional intelligence insight in communication platforms to provide users with recommendations for communication with recipients of communications, with such recommendations based on the psychometric profiles of the recipients.

### DESCRIPTION OF THE RELATED ART

The emotional intelligence quotient (also known as the emotional quotient or “EQ”) relates to a person's ability to understand, control, and use one's own emotions for effective communication, problem-solving, and conflict resolution by using emotional information to guide thinking and behavior. EQ is typically measured by way of psychometric assessment, and those tests generally ask a series of questions requiring the test-taker to answer by selecting the statements that describe him or her best. Based on those answers, a final score is returned to the test-taker representing his or her EQ. In addition to providing a numerical result, some EQ tests also provide the test-taker with information on aspects of their EQ, such as self-awareness, self-management, empathy, and social awareness, as well as information on how the test-taker can improve his or her EQ (perhaps based on lower-scoring areas). Improving one's EQ is desirable, as a high EQ is tied to better communication, lessened anxiety and stress, improved relationships, heightened empathy, and increased self-awareness, for example.

Despite the advantages of EQ tests, existing tests and testing platforms are rudimentary in nature and provide the test-taker with only the most basic insights as to his or her own emotional intelligence level. For example, an EQ test-taker's answers and results are generally private, reported and generated for his or her own personal information and self-awareness. Further, existing tests are structured to provide the test-taker with simple insights as to his or her own EQ for personal improvement, but do not offer insight as to the communication preferences, motivators, work styles, or EQ of people around the test-taker, for example. Such information would be extremely valuable to a test-taker to improve their interactions with others, providing increased team understanding, improved communication, collaboration, engagement, and overall performance. In addition to the above-described deficiency, existing EQ tests generally only provide the test-taker with his or her test results on the testing platform (such as an EQ test website) and in the form of a simple report. These results typically need to be printed, downloaded, or saved for their preservation—otherwise, they will be deleted upon exiting the testing platform. Much more desirable would be an innovative EQ testing platform, in combination with a software plug-in (also known as an extension or add-on, which adds new functions to a host program without altering the host program itself), that provides easy and convenient access to one's own EQ test results, preferences, and the like, as well as the same of others around the test-taker (such as employees within the same organization).

Therefore, in addition to the basic testing and result-providing functionalities, there is a need for an EQ testing platform and corresponding software plug-in to provide a test-taker with easy and convenient access to his or her own results, as well as the results, preferences, and the like of others around the test-taker. Such a solution would provide test-takers with insight as to their own behaviors, motivators, work style, and communication preferences, as well as the same of other test-takers within their company, organization, team, or group. Furthermore, there is a need for such results to be provided in a readily-accessible and convenient format, which would permit a user to view those insights, enabling the user to cater communications to other test-takers based on their preferences, styles, and the like.

### SUMMARY OF THE INVENTION

In view of the foregoing limitations associated with current EQ tests and related mechanisms, the present invention is directed to a system for providing emotional intelligence insight in communication platforms to provide users with recommendations for communication with recipients of communications, with such recommendations based on the psychometric profiles of the recipient(s). The recommendations may be insights as to the motivators, behaviors, and/or ideal environment of the recipient, including information on what the recipient values or finds effective when communicating or collaborating with others. Overall, the system aims to optimize engagement and collaboration, benefit relationships between individuals and groups, and enhance productivity within organizations.

More specifically, the preferred embodiment of the claimed system for providing emotional intelligence insight in communication platforms is comprised of a software program operative on a user device, such as a personal computer or mobile device, and in a most preferred embodiment, the software program is a plug in for any of a number of preexisting communication platforms such as GMAIL, MICROSOFT OUTLOOK, SLACK, MICROSOFT TEAMS, and the like. The software program may also be configured as a browser plugin or browser extension. The software program is configured to reference a psychometric profile corresponding to at least one recipient of a communication to be sent by a user via the communication platform or within the browser. By way of non-limiting example, the user device in any embodiment of the system may be a smartphone, computer, laptop, tablet, or any other device. Moreover, the communication platform in any embodiment may be a social networking website or application, an electronic mail platform, an instant messaging platform, an application for professionals, businesses, or offices, or any other type of communication website, application, platform, or program. Further, the software program in any embodiment of the system may be a plug-in, downloadable software, an add-on, an applet, or a browser extension.

The software program is configured to display to the user at least one recommendation for communication with the at least one recipient. In the preferred embodiment, the at least one recommendation may include a description of the at least one recipient's personality traits or work style, including insights as to the at least one recipient's behaviors (e.g., “tends to solve new problems quickly”), motivators (e.g., “enjoys learning for learning's sake”), and work energizers or styles (e.g., “likes to work with others”). In any embodiment, the at least one recommendation may be presented by any means, including textually, pictorially, via audio or audiovisual mechanisms, or any other means. For a deeper understanding, these insights help the user understand factors that might contribute to the efficiency or enjoyment of work for a certain recipient or group of recipients. In this embodiment, the at least one recommendation for communication with the at least one recipient is at least partially based on the psychometric profile corresponding to the at least one recipient.

In the preferred embodiment of the system, the psychometric profile of the at least one recipient is stored on a server, and the software program is configured to communicate with that server to access the psychometric profile. Upon accessing the profile, the software program displays the at least one recommendation within a modal window. By way of non-limiting example, the modal in any embodiment may be within the communication platform in a menu bar, ribbon, side panel, or itself constitute any of the same within the communication platform. In this embodiment, the at least one recommendation for communication is at least partially based on the psychometric profile pertaining to the user. The software program may also be further configured to display a plurality of psychometric profiles for a plurality of recipients, with the plurality of psychometric profiles being depicted in a spectrum arrangement in the preferred embodiment. In this regard, the user can see and understand group dynamics of a plurality of individuals, such as all the attendees in a meeting or all of the recipients of an email.

The method for the above-described embodiment includes receiving and storing a plurality of psychometric profiles pertaining to a plurality of potential communication recipients, and providing to the user at least one recommendation for communication with at least one of the plurality of potential recipients, with the at least one recommendation being at least partially based on the psychometric profile pertaining to the recipient. Further, in another embodiment, the method includes performing the step of providing the user at least one recommendation after being prompted by the user.

In the same or a different embodiment of the system, the communication platform is operable on at least one user device and includes a software component operable on the communication platform. The software component may again be a plug-in, add-on, applet, browser extension, or downloadable software, as in any embodiment. This embodiment further includes a test operable on a test platform, and a set of user input configured to respond to the test. The test is an emotional intelligence test or “EQ” test in the preferred embodiment, and the set of user input is comprised of the user's responses or answers to that test. There is also at least one server structured to receive the set of user input.

In this embodiment, the system further comprises a result generator, which may be contained within or a part of the server, configured to compare the set of user input to a set of reference data already in the server and produce a report. The report is preferably maintained and displayed in the form of a user profile (i.e. the test taker's psychometric profile), upon which the at least one recommendation for communication will be based, at least in part. Moreover, the user profile maintains and displays the report in an accessible format, preferably on a website that may be the same as that of the test platform. The report, and thereby the user profile, is structured to reflect the work style and communication preferences of the user, such as their work motivators, behaviors, environment ideals, and other characteristics or traits.

The software component in this embodiment is further comprised of at least one user interaction area that may be engaged to show information about the user as well as recommendations for communication with that user. The at least one user interaction area in any embodiment may be any graphical control element, such as a clickable area on the user's electronic mail address, a link to an external website, a sidebar button, or other clickable button or element within the modal or communication platform. The at least one user interaction area is structured to display an individual summary, with the individual summary configured to reflect the report on the communication platform within a modal. Additionally, the software component is further comprised of at least one analysis button in the preferred embodiment, but any graphical control element could be used. In this embodiment, the at least one analysis button is comprised of an individual analysis button that may be engaged to display the individual summary, reflecting the report. The individual summary comprises a detailed individual user summary configured to display the report on the communication platform, with the communication platform structured to present the report within the modal, the modal comprising at least one modal menu. Further, the individual summary may also comprise a brief individual user summary configured to display a condensed version of the report on the communication platform, with the communication platform structured to present the report within the modal. An embodiment that displays the brief individual user summary may be further comprised of a detailed view action area within the modal, the engagement of which displays the user profile on the at least one user device or the individual user summary in full within the modal. By way of non-limiting example, the detailed view action area might take the form of a clickable hyperlink within the modal that navigates to the user profile on the test platform to show deeper insights about the user, a clickable button within the modal that navigates to the same, or either a hyperlink or button within the modal that is engaged to display the user profile or detailed individual user summary within the communication platform and/or modal.

Moreover, the at least one analysis button may also be comprised of a group analysis button. The group analysis button is engaged to display a group summary in the preferred embodiment, with the group summary structured to reflect at least one characteristic from the report of each user in a group that may receive a communication from the user. The at least one characteristic from the report of each user in the group is summarized and displayed to show cultural trends of the group for the user's consideration and analysis. Those characteristics might be displayed in a spectrum arrangement within the communication platform, and preferably within the modal. The spectrum arrangement might also display subgroups in any embodiment, with members of the same subgroup or subgroups having the same at least one characteristic. For example, the group summary might display in the spectrum arrangement which members of the group, or how many members in the group, are “stability-oriented” workers versus “change-oriented” workers. The modal may be comprised of at least one modal menu in this embodiment, with the different modal menus containing separate summaries or spectrum arrangements that correspond to different group characteristics.

The method for providing emotional intelligence insight corresponding to this embodiment of the system includes: displaying a test on at least one user device within a test platform; gathering a set of user input from a user taking the test; transmitting the set of user input to at least one server; comparing the set of user input to a set of reference data; generating a report with a result generator, where the report reflects at least the work style and communication preferences of the user; and enabling a software component to access the report of the user to display information from the report within a communication platform on the at least one user device, where the software component comprises at least one analysis button. The method may further comprise creating a user profile to maintain the report in an accessible format and storing the report of the at least one server. Additionally, the method may also include engaging with the at least one analysis button to display an individual summary that reflects the report corresponding to the user. The method may also include displaying the individual summary in a detailed manner within the communication platform on a modal. Further, the method might also include engaging with the at least one analysis button to display a group summary reflecting at least one characteristic from the report of each user in a group.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic depiction of a test platform displayed on a user device in accordance with one embodiment of the present invention.

FIG. 2 is a schematic depiction of a test platform displayed on a user device in accordance with one embodiment of the present invention.

FIG. 3 is a schematic depiction of an inventive software component integrated with a communication platform in accordance with one embodiment of the present invention.

FIG. 4 is a depiction of an inventive software component integrated with a communication platform in accordance with one embodiment of the present invention.

FIG. 5 is a depiction of a modal menu displaying an individual user summary in accordance with one embodiment of the present invention.

FIG. 6 is a depiction of a modal menu displaying an individual user summary in accordance with another embodiment of the present invention.

FIG. 7 is a depiction of a modal menu displaying a summary of a group of users in accordance with one embodiment of the present invention.

FIG. 8 is a depiction of a modal menu displaying an individual user summary in accordance with another embodiment of the present invention.

FIG. 9 is a depiction of a user profile in accordance with one embodiment of the present invention.

FIG. 10 is a depiction of a user interaction area embedded within a communication platform in accordance with one embodiment of the present invention.

FIG. 11 is a depiction of a modal menu displaying a summary of a group of users in accordance with the embodiment of FIG. 10.

FIG. 12 is a depiction of a modal menu displaying an individual user summary in accordance with one embodiment of the present invention.

FIG. 13 is a depiction of a communication platform that may be used in connection with one embodiment of the present invention.

FIG. 14 is a depiction of a user interaction area integrated into the communication platform shown in FIG. 13.

FIG. 15 is a depiction of an individual user summary in accordance with the embodiment shown in FIGS. 13 and 14.

FIG. 16A is a depiction of a group summary in accordance with one embodiment of the present invention.

FIG. 16B is a depiction of an alternative modal menu of the embodiment of FIG. 16A. Like reference numerals refer to like parts throughout the several views of the drawings.

### DETAILED DESCRIPTION OF THE PREFERRED EMBODIMENT

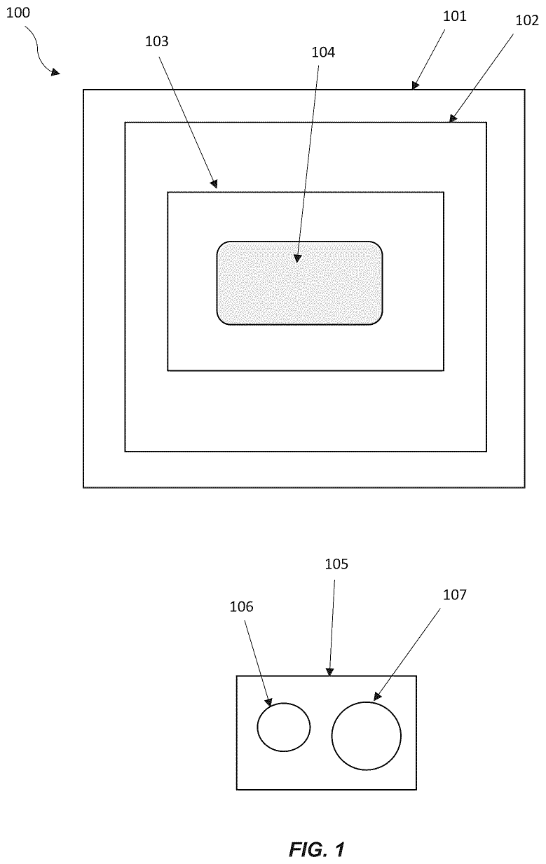

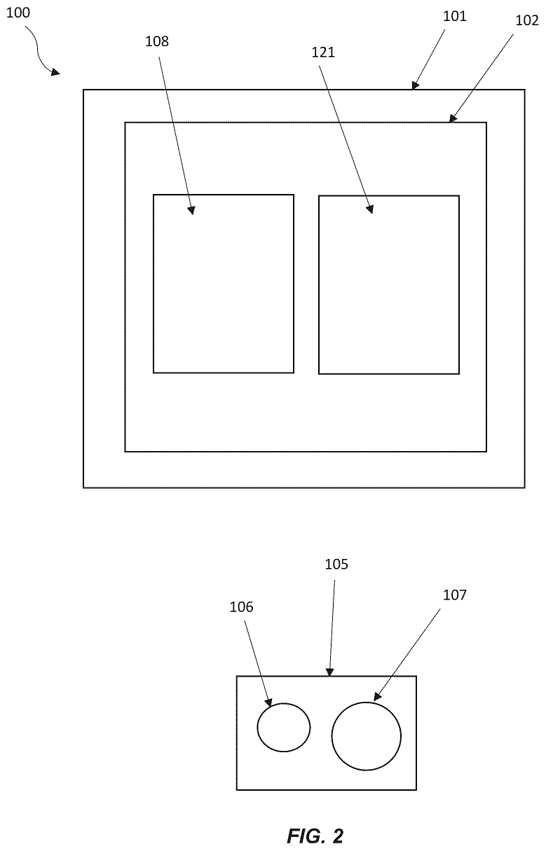

Before disclosing the salient details of the present invention, it is necessary to briefly establish some antecedents. With reference to FIGS. 1-2 a schematic depiction of a test platform is disclosed. The principal aim of the test platform is to gather data pertaining to a group of users, and store that data in a database for the inventive software to later reference. In a preferred embodiment, the test platform is styled as a self-assessment where the user can use his or her own user device 101 to access the test platform 102 and submit user input 104 to the test platform 102. The test platform 102 can optionally generate a report 108 and/or user profile 121. In at least one embodiment, the test platform 102 is in communication with at least one server 105 where reference data 106 is stored and a result generator module 107 may be operative to run. The result generator module 107 may be configured to compare the user input 104 to the reference data, which may include a plurality of personality archetypes, in order to assign the user to one or more of the personality archetypes. Therefore, the report 108 and/or user profile 121 may present insights and characteristics of the user as relative to one or more of the personality archetypes. As such, and as will be disclosed in further detail below, the inventive system is operative to provide insight and recommendations to other users who wish to communicate with the test taker in terms of the characteristics of the one or more personality archetypes to which the test taker has been assigned.

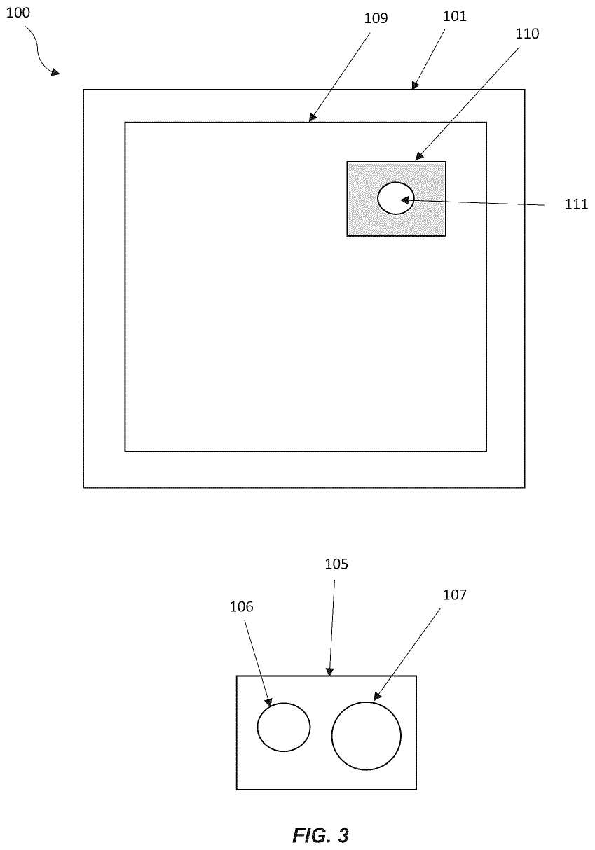

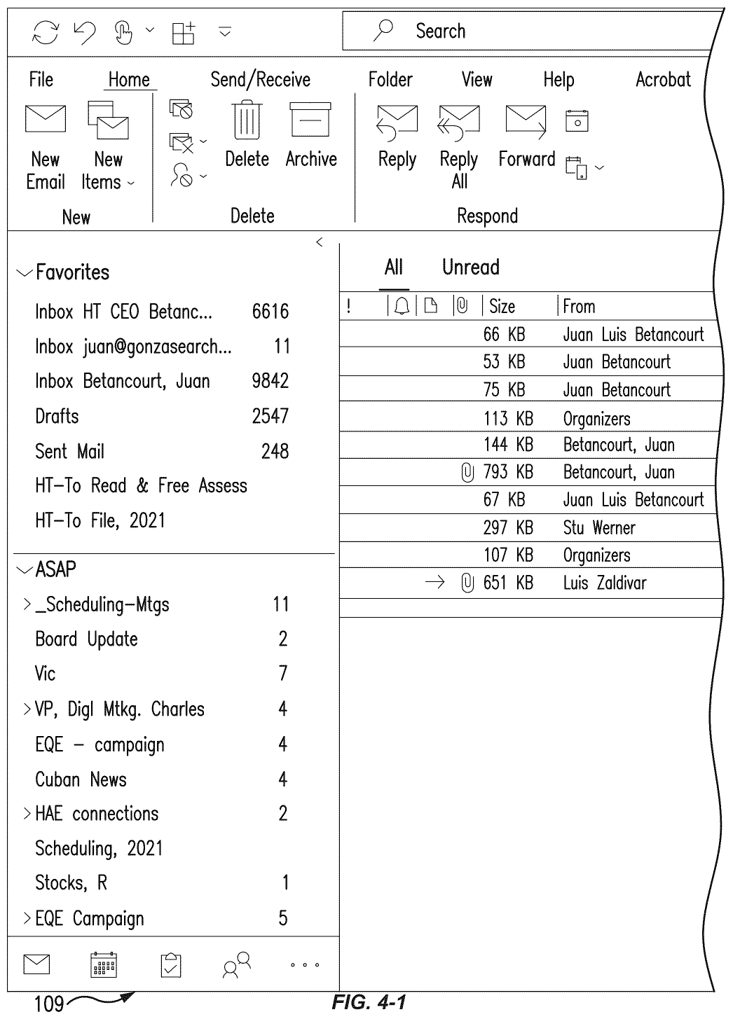

Now turning to FIG. 3, a schematic depiction of one embodiment of the present invention shows a general implementation of the inventive principals in a generic communication platform. A user device 101 may be used to access a communication platform 109 such as email software, a social media website or application, or an instant messaging system. In basic principle and in the most preferred embodiment, the system 100 of the present invention is designed as a software component 110 that can be implemented in the desired communication platform 109. The software component 110 can be implemented as a plug-in, applet, browser extension, and the like, and may include graphical user interface components that integrate with the communication platform. In a preferred embodiment, the system 100 also includes at least one analysis button 111 which allows a user to access insights or recommendations relative to other users.

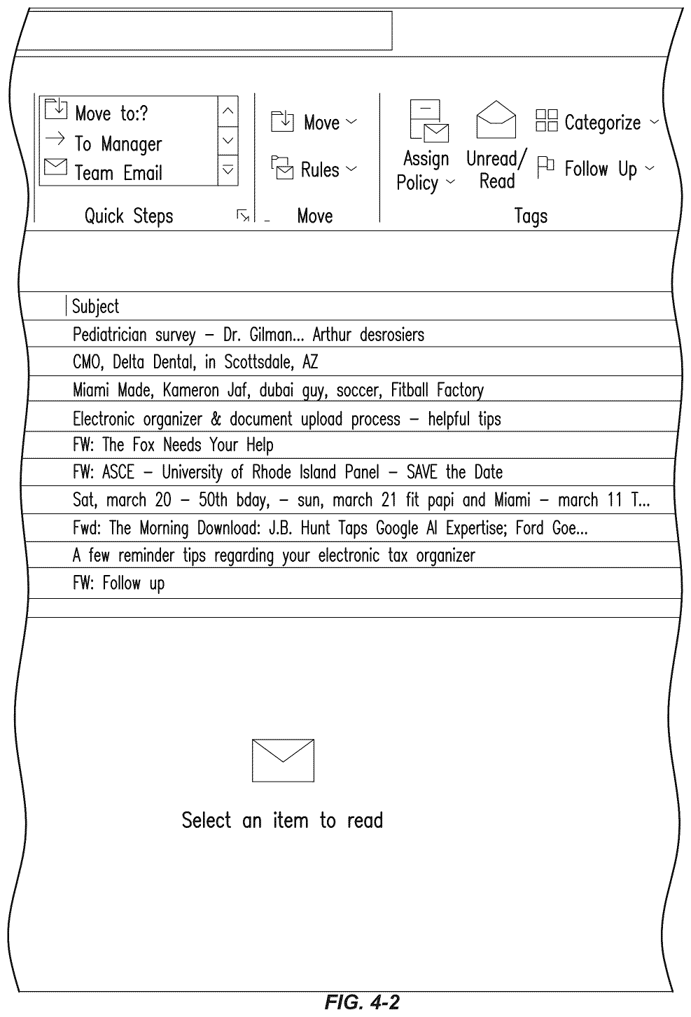

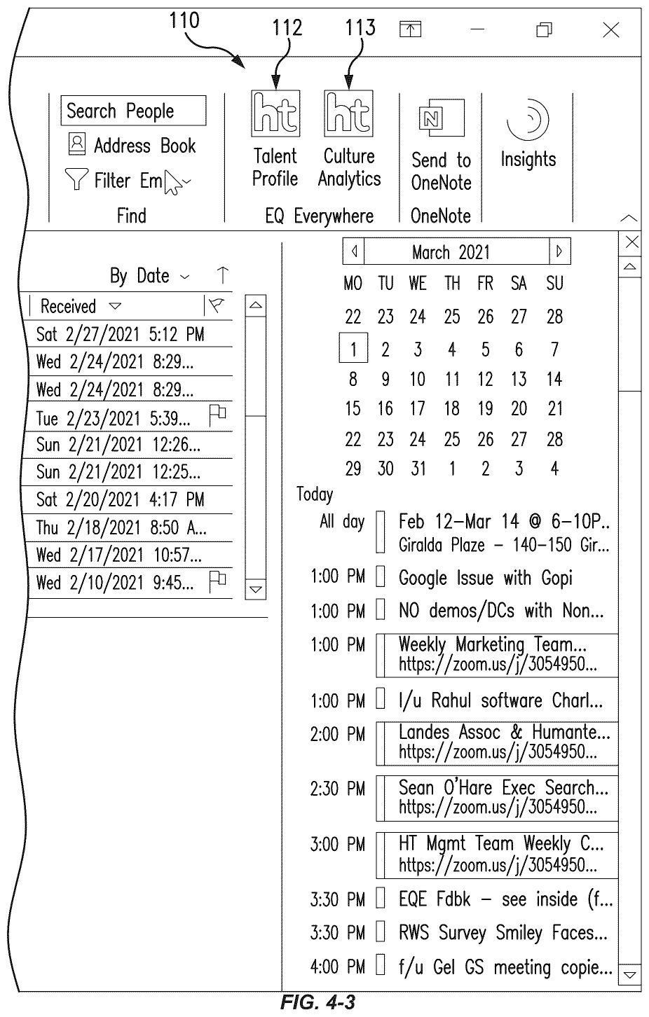

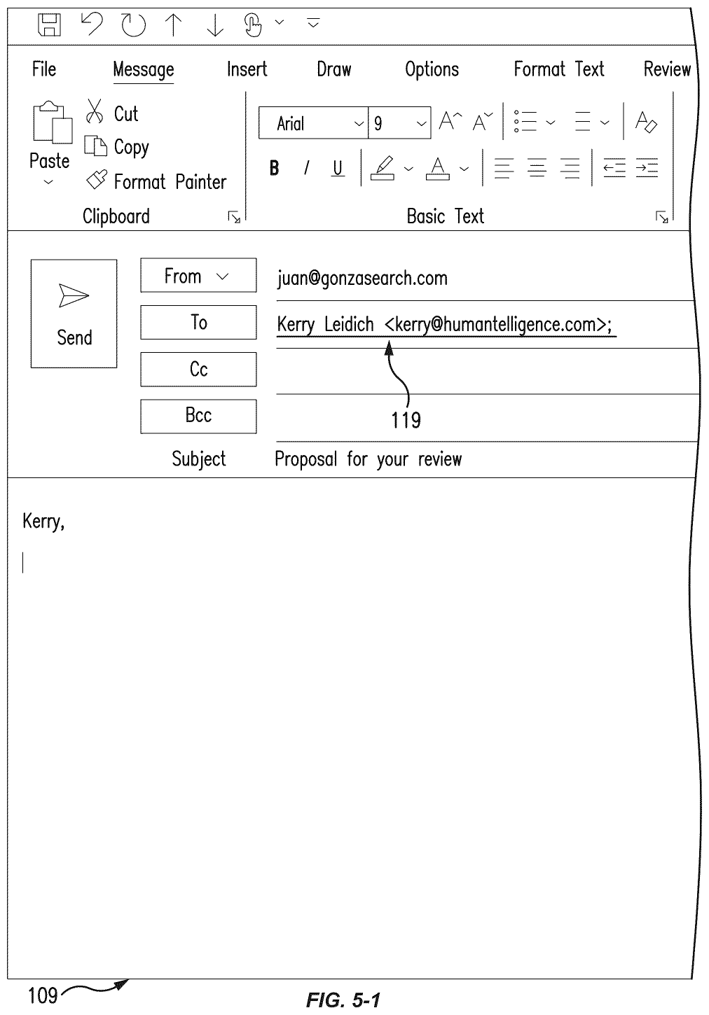

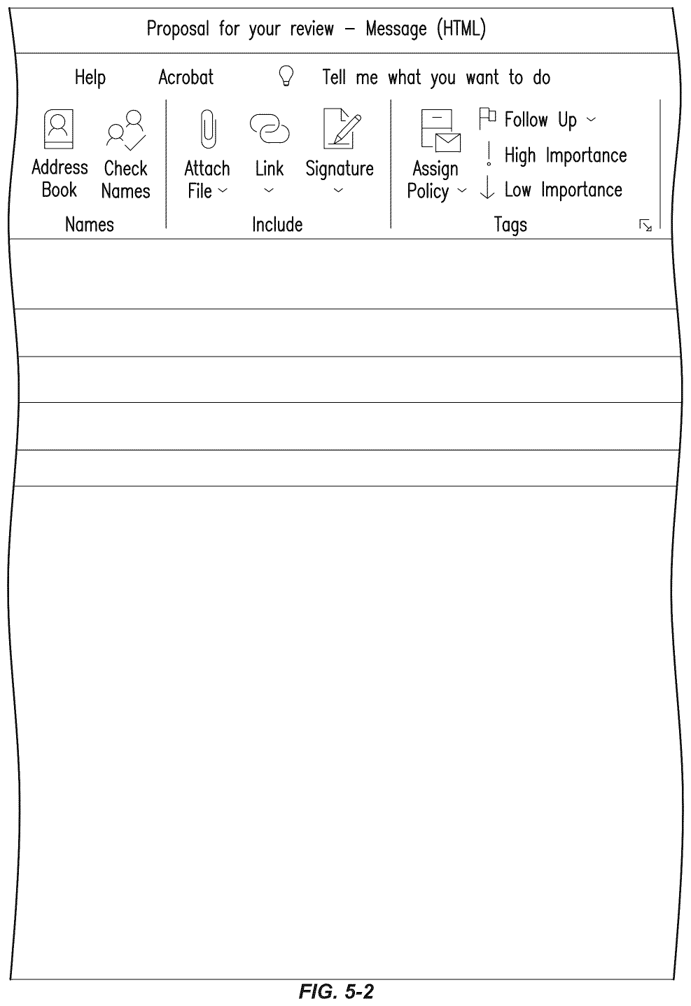

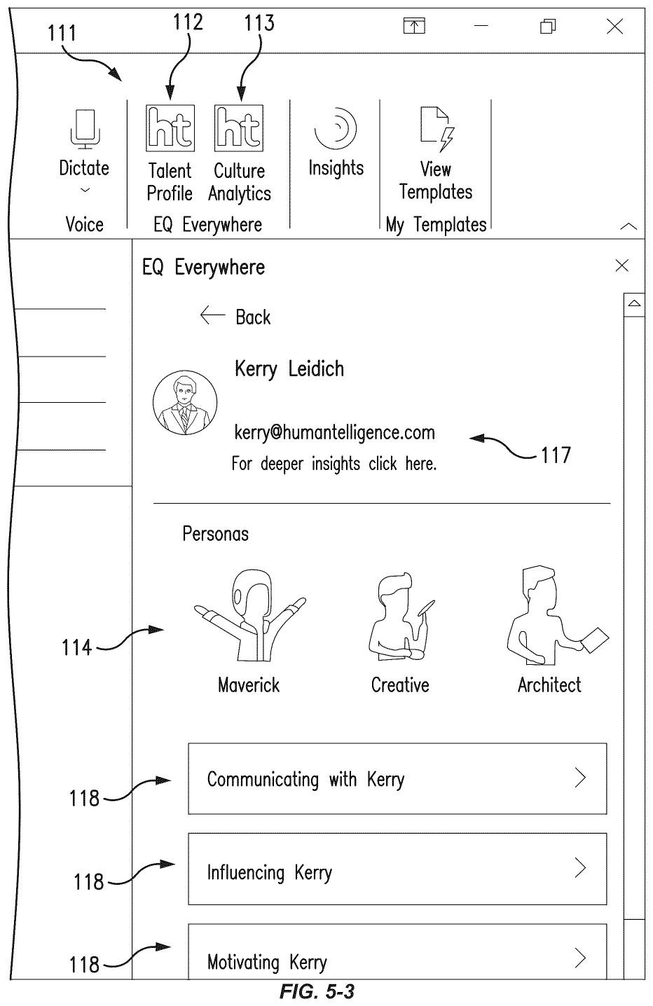

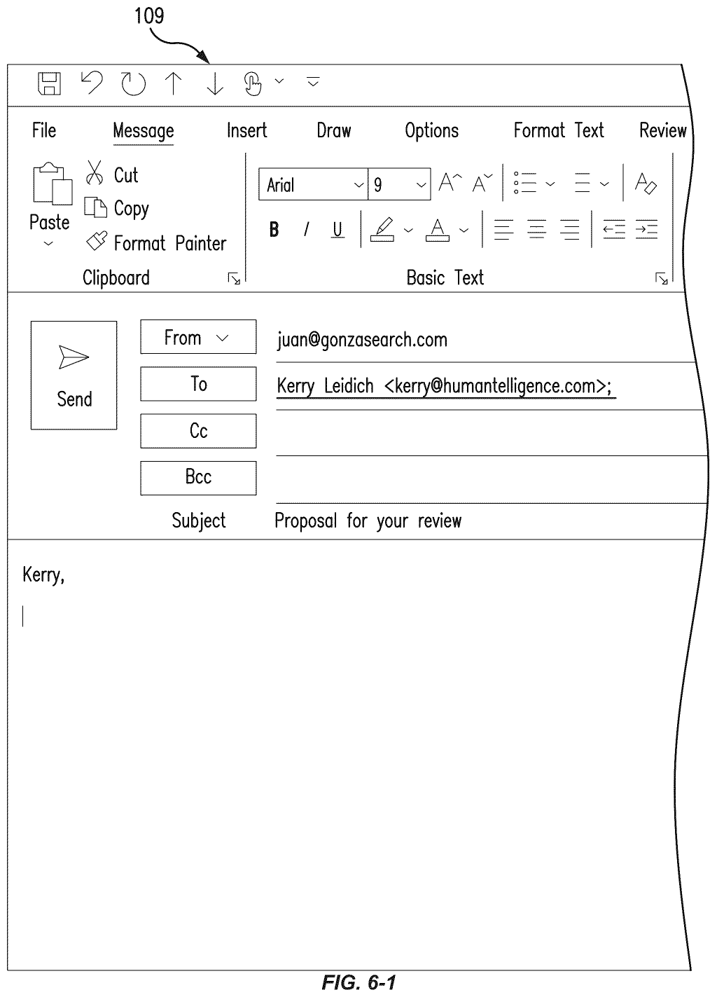

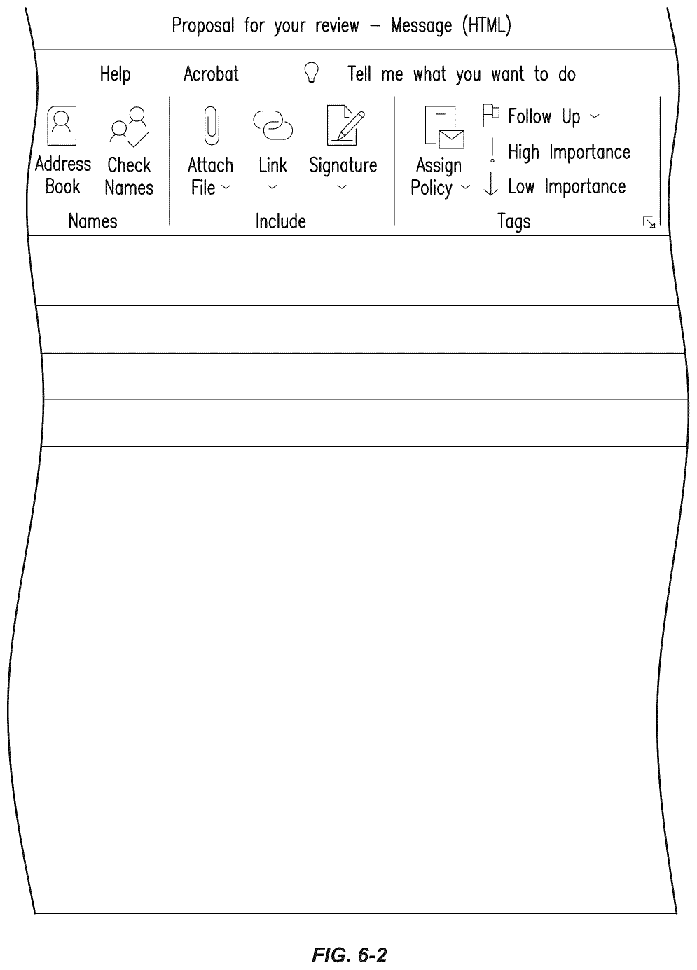

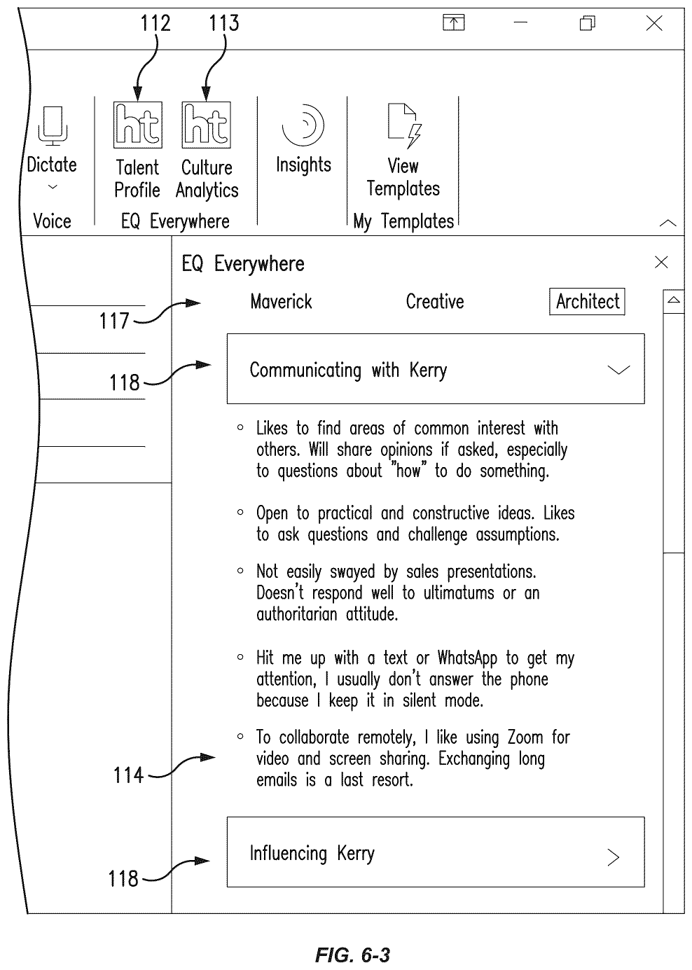

Turning to FIGS. 4-7, one embodiment of the present invention is shown where the software component 110 of the system is integrated into an email communication platform 109. In the exemplary embodiment, the user is provided with two analysis buttons, an individual analysis button 112 and a group analysis button 113. As is shown in FIG. 5, when the user interacts with one of the buttons, the system is operative to present the user with a modal 117, which in this case is a detailed individual user summary 114 that provides the user with a plurality of modal menus 118. In the depicted embodiment, the modal menus 118 include recommendations for communicating with the individual, for interacting with the individual, and for motivating the individual. In a preferred embodiment, the user will first enter a recipient's name or handle into a user interaction area 119. Afterward, when the user interacts with one of the software components 110, the system is operative to display a modal 117 having information relevant the recipient or recipients, assuming that the system can access information about the recipient(s), such as test results or personality archetypes associated with the recipient(s). Accordingly, as seen in FIG. 6, when the user interacts with one of the modal menus 118, more information about the recipient is presented. In the exemplary embodiment, the user has clicked on the modal menu 118 having information about communicating with the recipient, and the modal menu 118 has presented more detailed individual summary 114 in the form of recommendations for effectively communicating with the recipient.

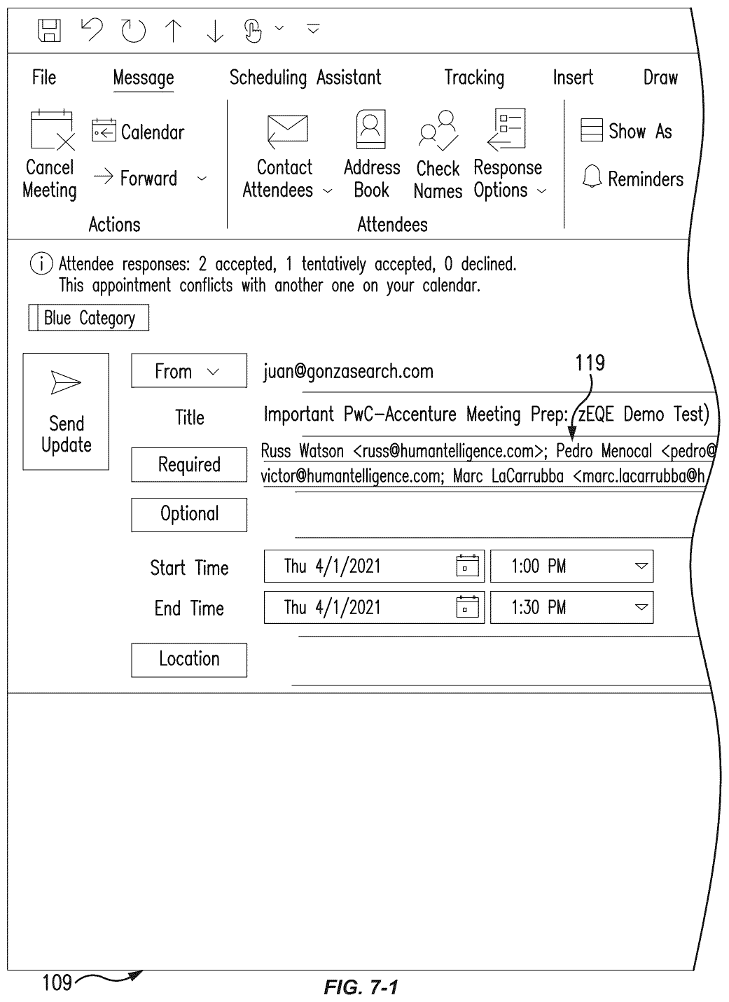

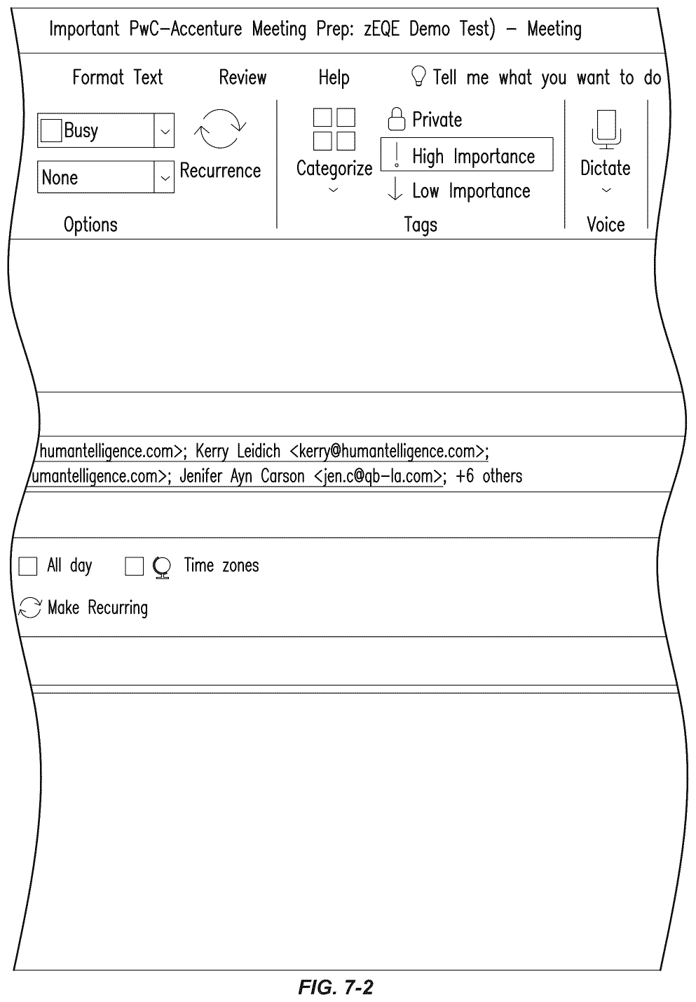

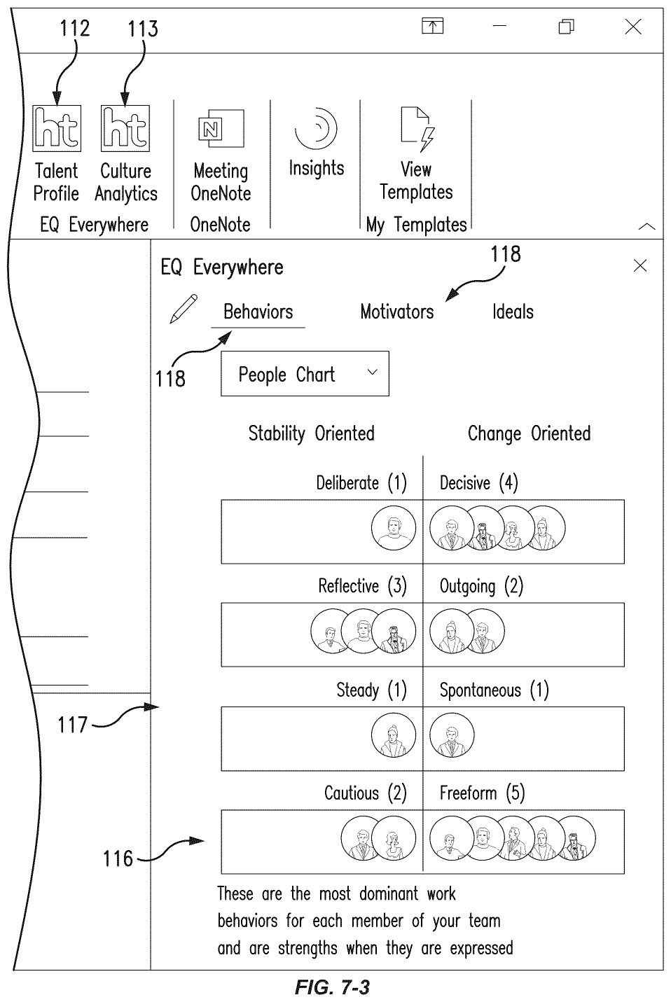

In FIG. 7 the system is shown in operation when a communication platform 109 is used to schedule a meeting with a number of attendees. As can be seen, there are a number of recipients listed in the user interaction area 119, in this case the list of attendees for the meeting. Accordingly, the modal 117 is operative to display a group summary 116 in which the attendees are mapped on spectrums of their most dominant work behaviors. Additional modal menus 118, such as motivators and ideals, are operative to display different characteristics of the group.

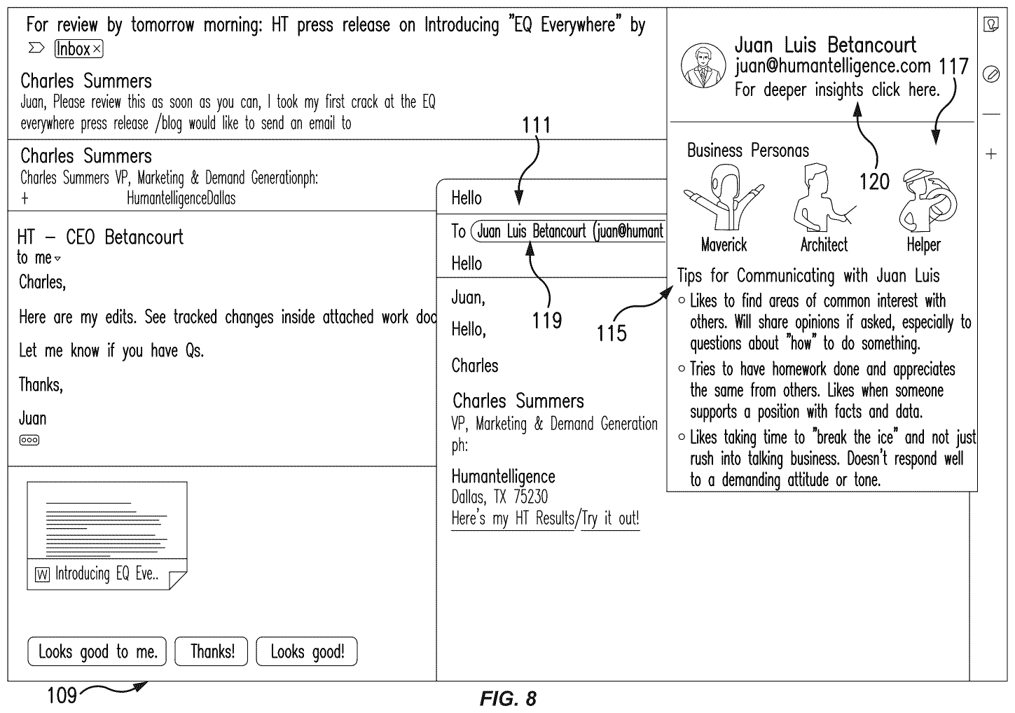

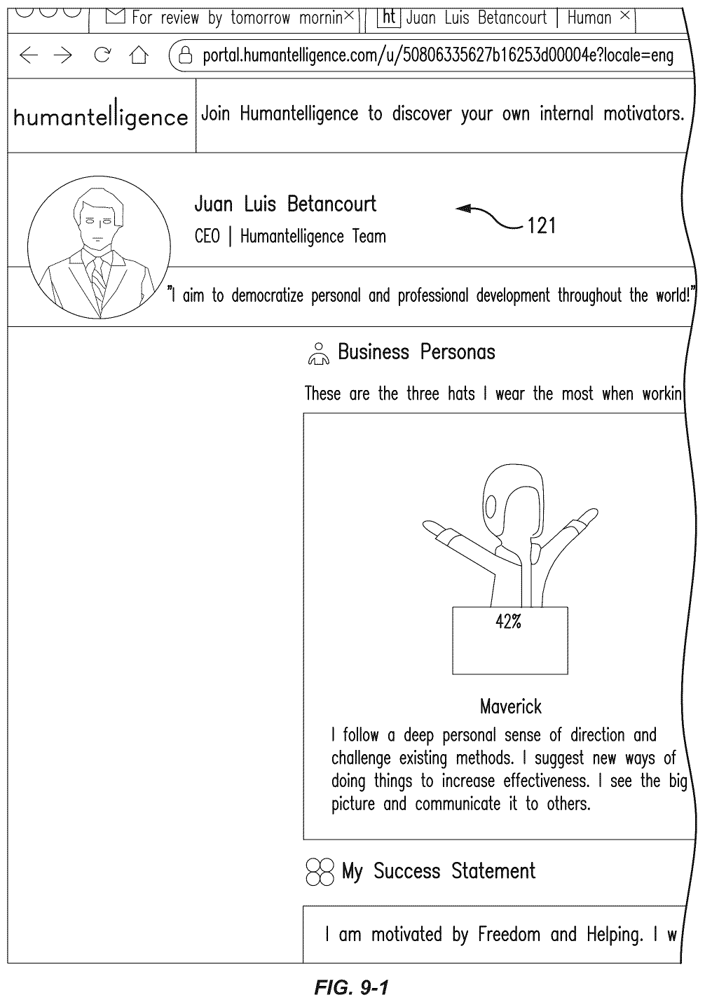

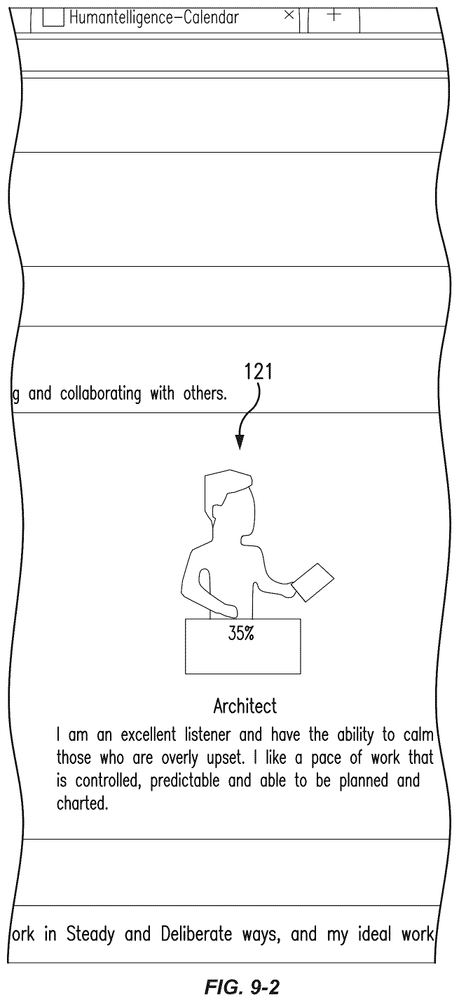

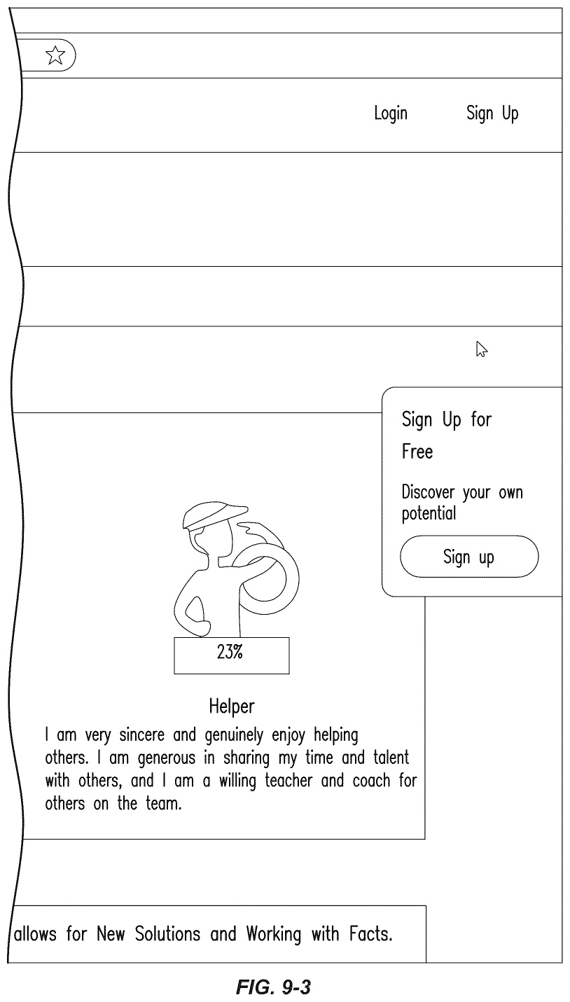

FIG. 8 depicts a communication platform 109 that is accessed via a web browser. In such an embodiment, the system 100 may be implemented as a web browser extension and may be operative upon browsing to one of a plurality of predetermined websites. In the depicted embodiment, the user interaction area 119 is the recipient field of a draft email window. Additionally, the at least one analysis button 111 can also be integrated into the recipient field, such as by making the recipient a clickable link, or by including an additional function into the list of “right-click” features available. In any event, the modal 117 is operative to display either group or, in this case, a brief individual analysis 115. The exemplary embodiment is shown with a brief individual analysis 115, as opposed to the previously shown detailed analysis, because screen space limitations may be at play when accessing a communication platform via a web browser, instead of a dedicated software application. Accordingly, a detail view action button 120 may be presented to the user, whereupon interacting with the detail view action button 120, the user may be redirected to another webpage, shown in FIG. 9, which includes a full user profile 121. A full user profile 121 may include personality archetypes and other information.

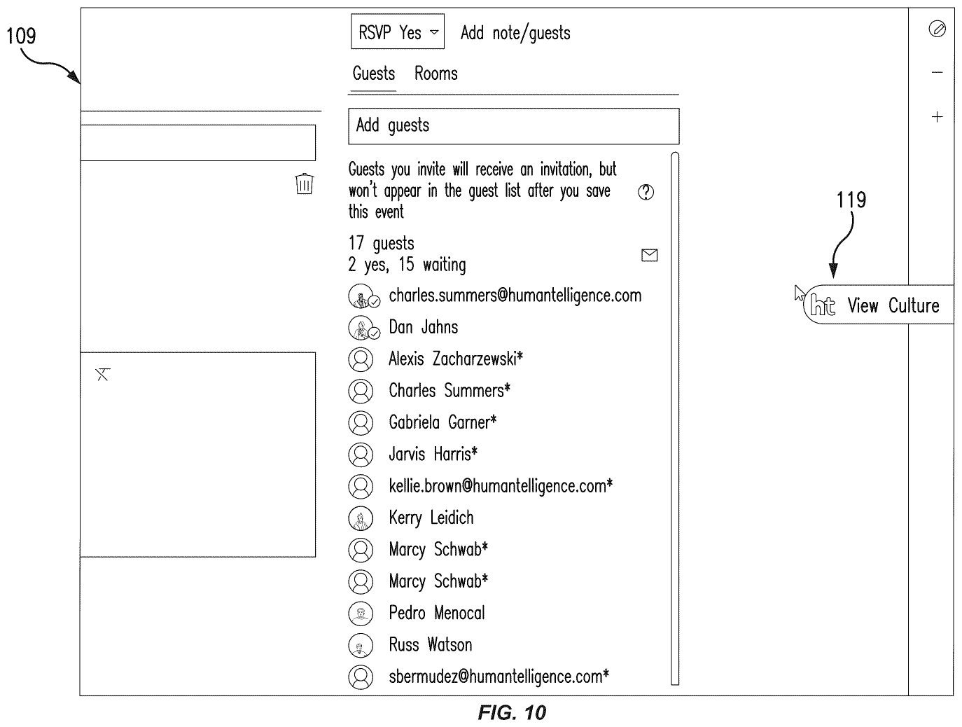

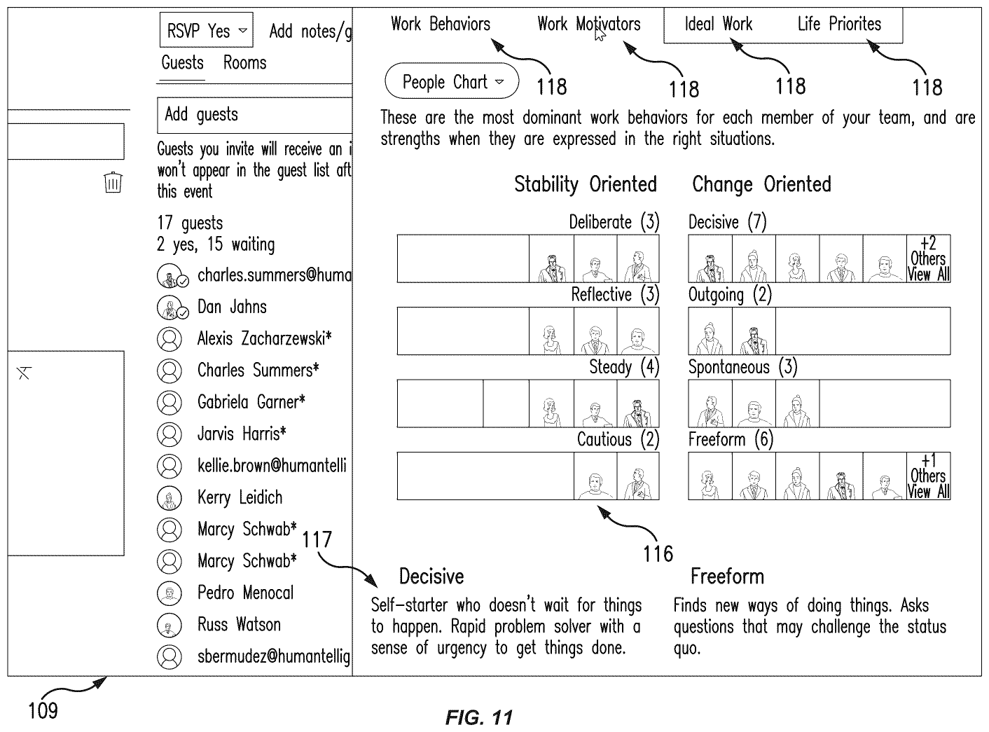

FIG. 10 depicts a web-based communication platform in which a user may plan a meeting and invite attendees. The user interaction area 119 is presented as a button in which the user may view the group dynamics of all of the attendees added to the meeting invitation. As can be seen in FIG. 11, when the user clicks on the user interaction area 119, a group summary 116 is displayed as a modal 117 including a plurality of modal menus 118. As in previously disclosed embodiments, the group dynamics are displayed by plotting the attendees on spectrums of various characteristics, such as work behaviors, work motivators, ideal work environment, and life priorities, which the user can view by clicking on the modal menus 118.

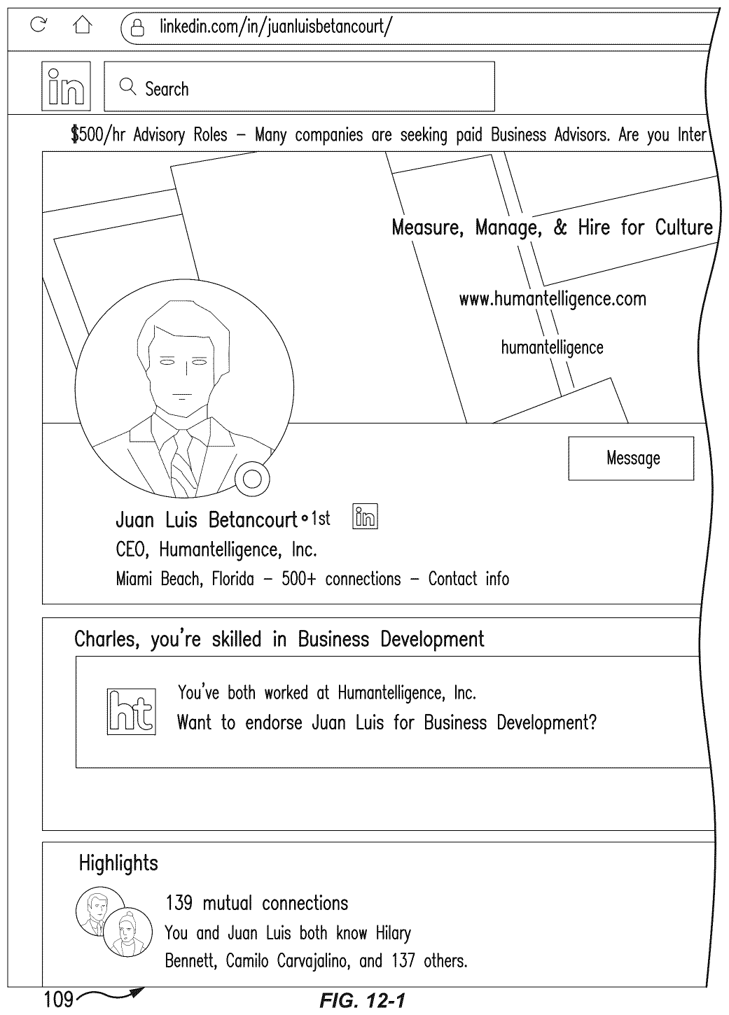

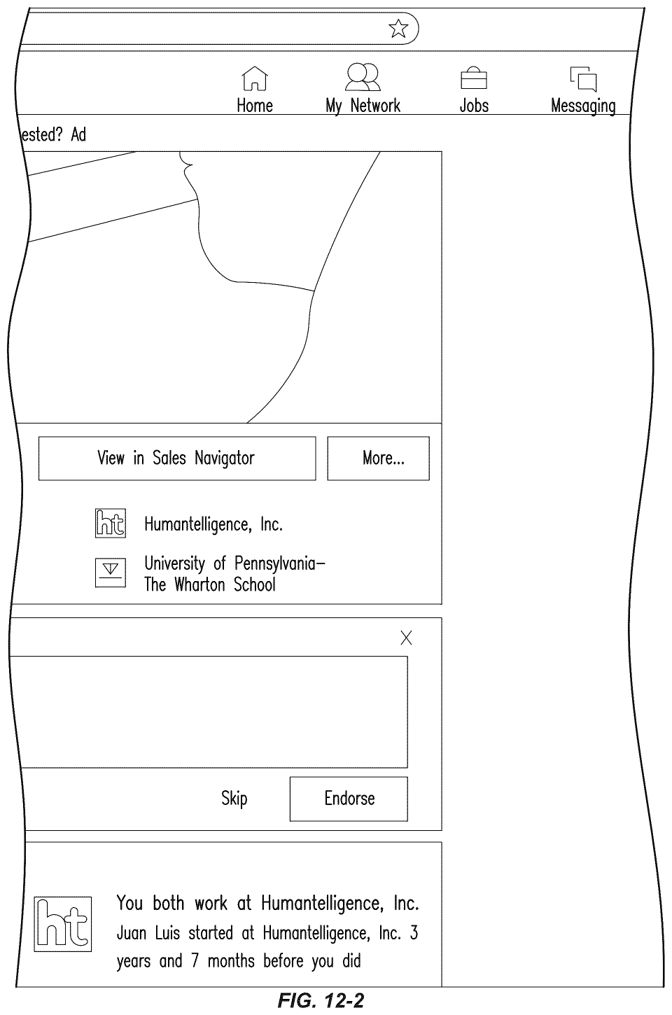

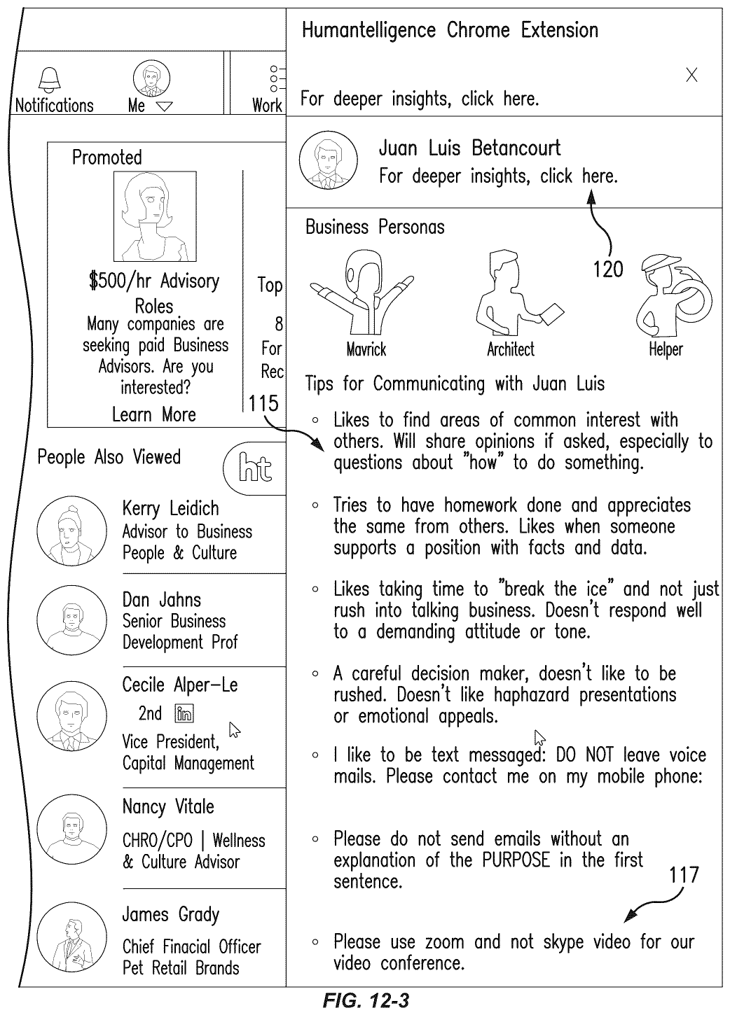

FIG. 12 depicts the system of the present invention implemented in a communication platform 109 that consists of a web accessible social media site. As with previous web accessible embodiments, the modal includes a brief individual summary 115 of the person whose profile is currently being viewed and also provides a detailed view action area 120, which as disclosed previously, may take the user to a full profile page located on a separate webpage.

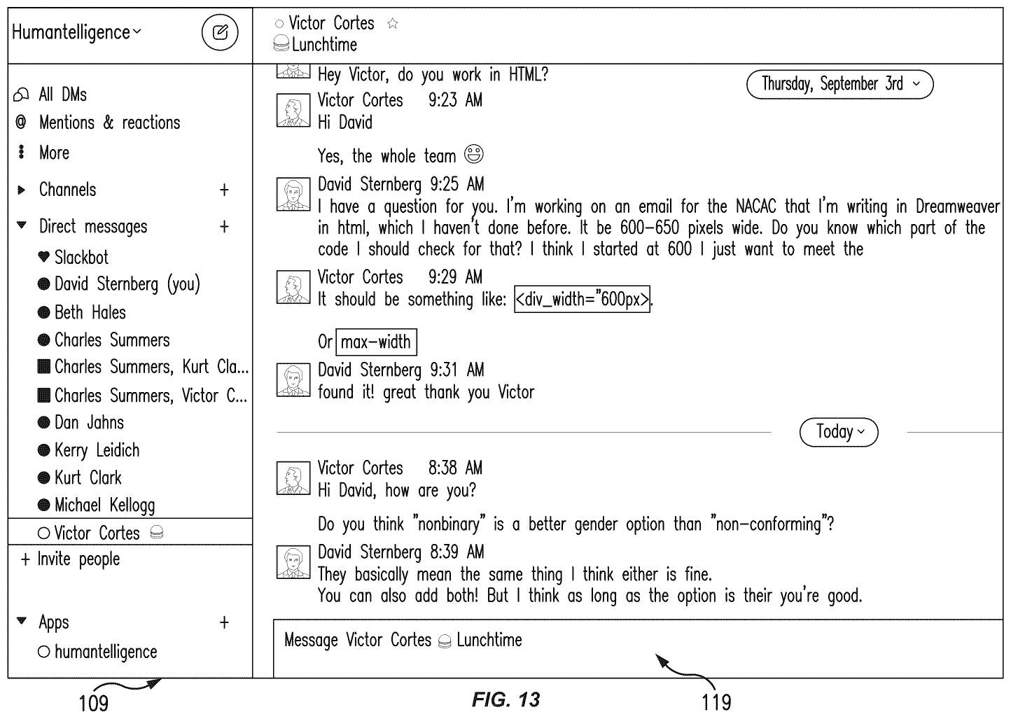

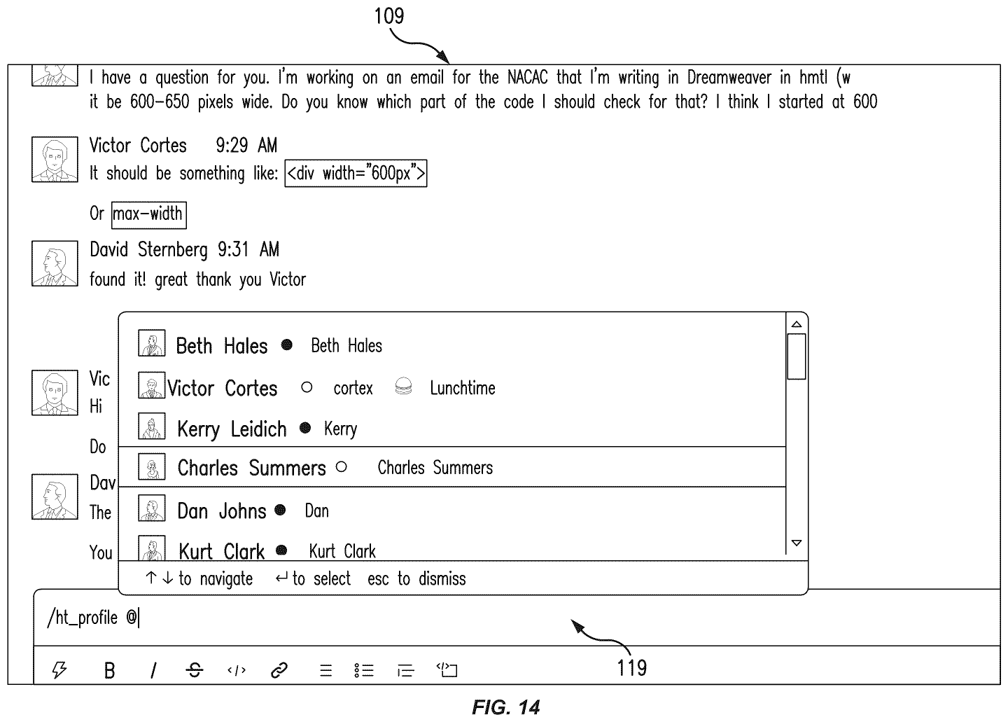

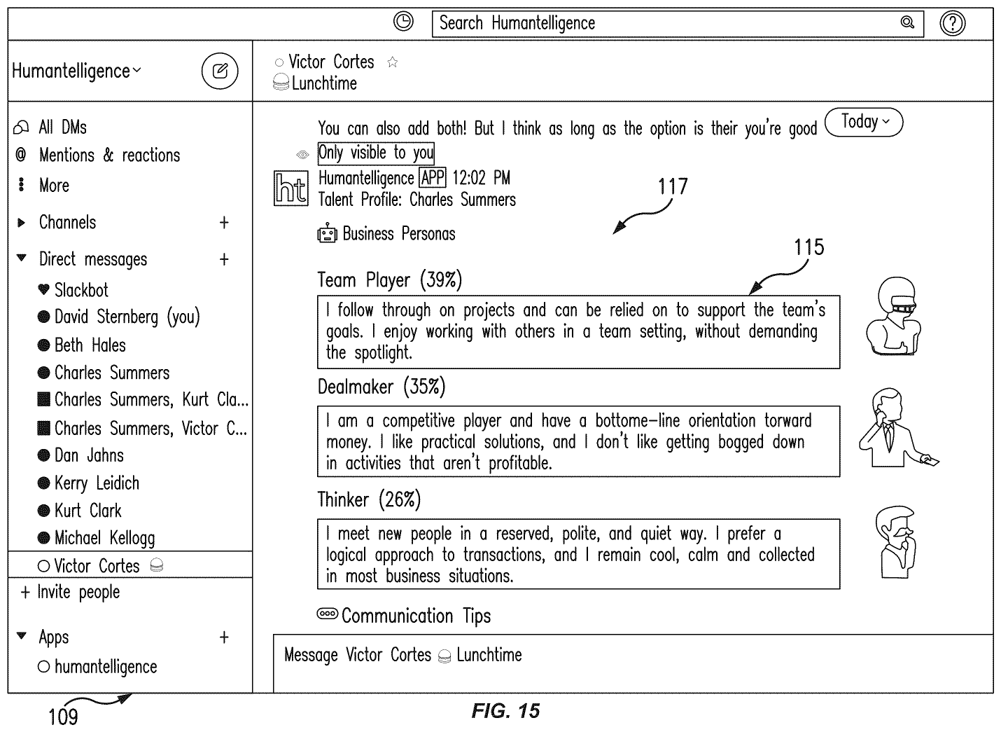

FIGS. 13-15 depict the system of the present invention implemented in a communication platform 109 that consists of an instant messaging system and, furthermore, depicts an embodiment that does not change or add to the user interface of the communication platform, e.g., by adding additional buttons in a ribbon or the like. Instead, the user interaction area 119 is the text input field of the messaging system. The system of the present invention is operative to recognize a plurality of key terms when input into the user interaction area 119. In the depicted embodiment, one operative key term is/ht_profile @[NAME], where [NAME] is the name or handle of the person for which the desired user profile is sought. Entry of this key term into the user interaction area 119 primes the system to look for user profiles matching that name entered after the @ symbol and, as depicted in FIG. 14, may be further operative to display a list of the available user profiles. As can be seen in FIG. 15, once the desired user profile is selected, the system displays he relevant profile and/or recommendations within the chat field, although the relevant output is only visible to the user, and is not visible to the recipient.

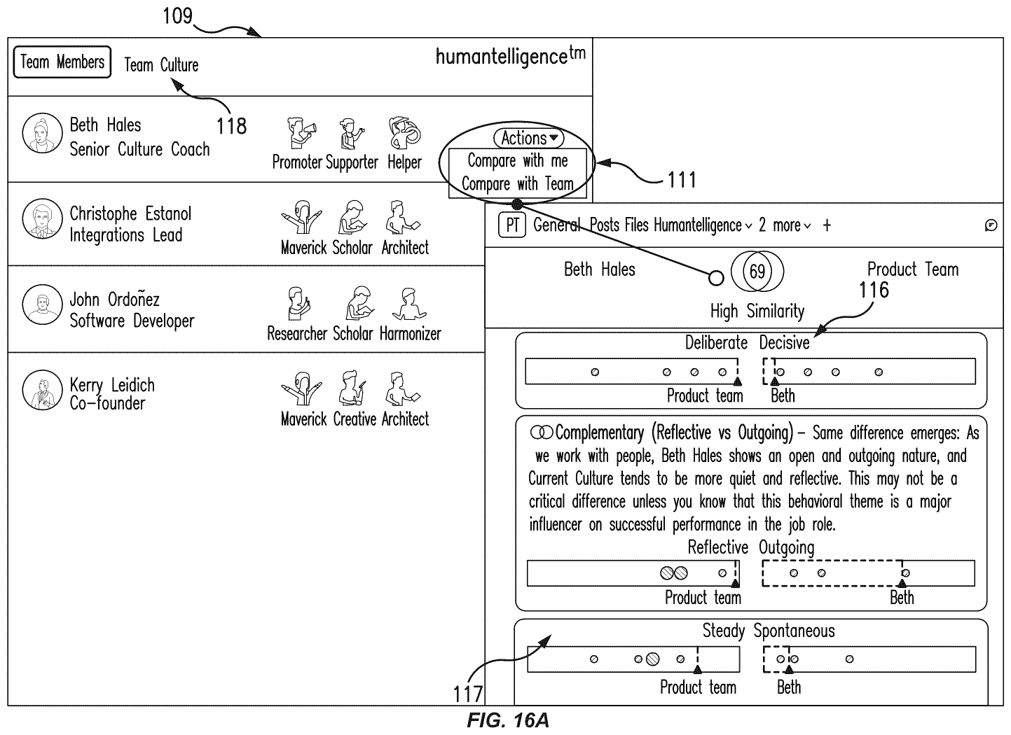

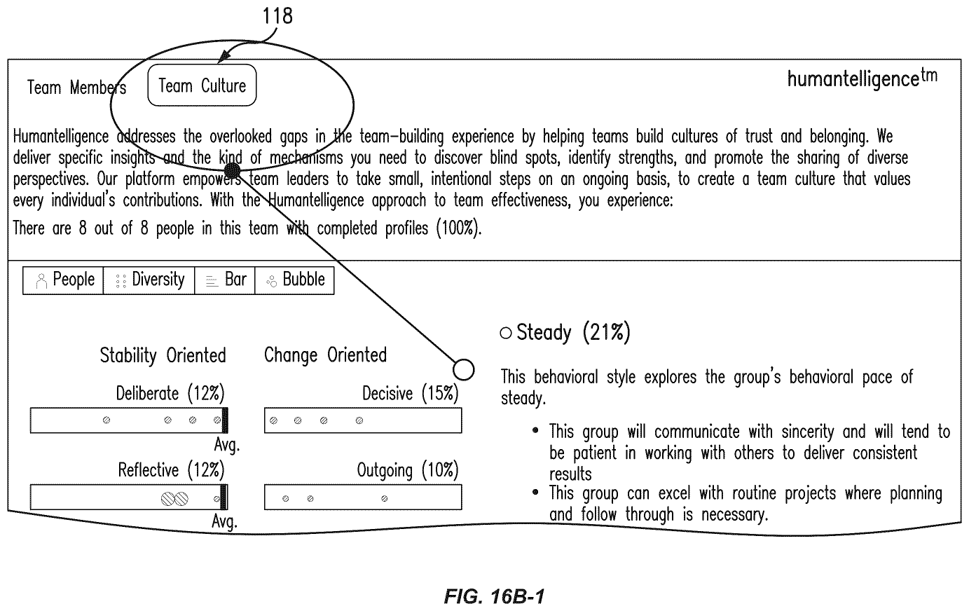

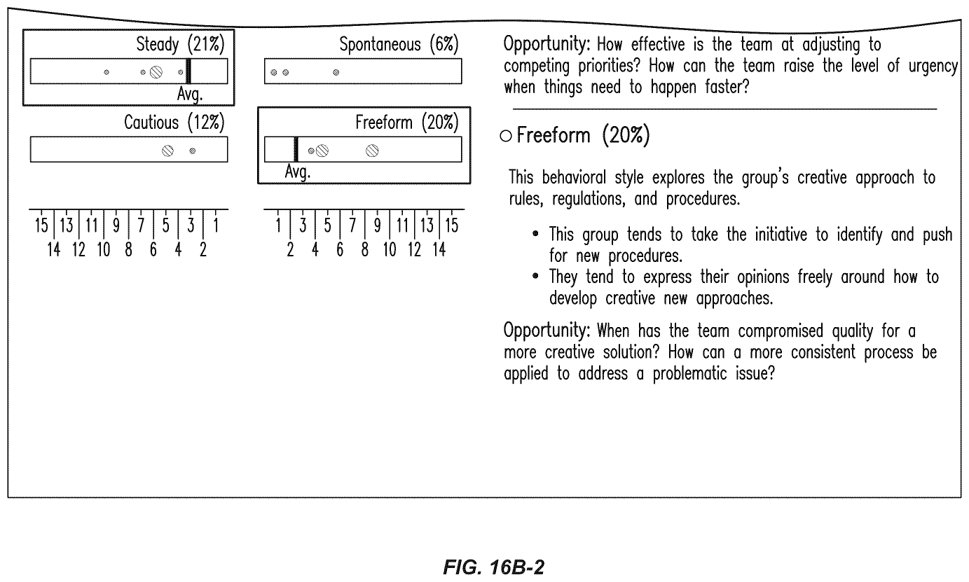

Now turning to FIGS. 16A-16B, another embodiment is presented in which the present invention is implemented in a team-based communication platform 109, such as MICROSOFT TEAMS. In such a platform, team groups are created from a subset of an entire organization. Thus, the group cultural dynamics should be assessed and displayed dynamically as team groups are created or modified. Real time assessment and management of the group culture enables a team leader to view strengths and weaknesses in the gaps, add members to fill gaps, and see updated team culture assessments in real time. FIG. 16A depicts a portion of a communication platform 109 having analysis buttons 111 which permit the user to compare any member of the team with either the user or the rest of the team. Group summaries 116 are displayed within a modal 117 having team member characteristics displayed along a plurality of spectrums. The group summaries 116 also show a team average for a given characteristic, as well as the placement of a particular team member along the spectrum representing the characteristic. FIG. 16B depicts an alternative menu modal 118 of the embodiment shown in FIG. 16A where further group culture dynamics are displayed to the user. Specifically, the diversity of characteristics among the team members are displayed as plots along various spectrums and written descriptions are provided which pertain to dominant characteristics of the group. Accordingly, the user can identify weaknesses in the assembled team group.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A system for providing emotional intelligence insight in communication platforms, said system comprising:
a software program operative with the communication platform and accessible via a user device;
said software program further configured to reference a psychometric profile corresponding to at least one recipient of a communication to be sent by a user via the communication platform;
said software program further configured to display to the user at least one recommendation for communication with said at least one recipient.

2. The system as recited in claim 1, wherein said at least one recommendation for communication with said at least one recipient is at least partially based on said psychometric profile corresponding to said at least one recipient.

3. The system as recited in claim 1, wherein said psychometric profile is stored on a server, said software program configured to communicate with said server in order to access said psychometric profile.

4. The system as recited in claim 1, wherein said software program displays said at least one recommendation within a modal window.

5. The system as recited in claim 1, wherein said at least one recommendation for communication is at least partially based on a psychometric profile pertaining to the user.

6. The system as recited in claim 1, wherein said software program is further configured to display a plurality of psychometric profiles for a plurality of recipients, said plurality of psychometric profiles being depicted in a spectrum arrangement.

7. A method of providing emotional intelligence insight in communication platforms, said method comprising:
receiving and storing a plurality of psychometric profiles pertaining to a plurality of potential communication recipients;
providing to the user at least one recommendation for communication with at least one of the plurality of potential recipients, the at least one recommendation being at least partially based on the psychometric profile pertaining to said recipient.

8. The method as recited in claim 7, wherein the plurality of psychometric profiles are stored on a server, the user utilizing a user device to access the communication platform.

9. The method as recited in claim 7, wherein said step of providing to the user at least one recommendation is performed after being prompted by the user.

10. A system for providing emotional intelligence insight, said system comprising:
a communication platform operable on at least one user device;
a software component operable on said communication platform;
a test operable on a test platform;
a set of user input configured to respond to said test; and
at least one server configured to receive and store said user input.

11. The system as recited in claim 10, wherein said system further comprises a result generator configured to compare said user input to a set of reference data and produce a report; said report structured to reflect at least one personality archetype associated with the user.

12. The system as recited in claim 11, wherein a user profile is configured to maintain and display said report in a user accessible format.

13. The system as recited in claim 10, wherein said software component is comprised of at least one user interaction action area.

14. The system as recited in claim 13, wherein said at least one user interaction area is structured to display an individual summary; said individual summary being reflective of said report on said communication platform within a modal.

15. The system as recited in claim 10, wherein said software component is comprised of at least one analysis button.

16. The system as recited in claim 15, wherein said at least one analysis button is comprised of an individual analysis button.

17. The system as recited in claim 16, wherein said individual analysis button is configured to display said individual summary; said individual summary structured to reflect said report.

18. The system as recited in claim 17, wherein said individual summary comprises a detailed individual user summary configured to display said report on said communication platform; said communication platform structured to present said report within said modal comprising at least one modal menu.

19. The system as recited in claim 17, wherein said individual summary comprises a brief individual user summary.

20. The system as recited in claim 19, wherein said modal is structured to contain a detailed view action area; said detailed view action area configured to display said user profile on said at least one user device.

21. The system as recited in claim 18, wherein said at least one analysis button is a group analysis button.

22. The system as recited in claim 21, wherein said group analysis button is configured to display a group summary; said group summary structured to reflect at least one characteristic of each user in a group.

23. The system as recited in claim 22, wherein said communication platform is structured to display said group summary within said modal.

24. The system as recited in claim 23, wherein said modal comprises at least one modal menu.

25. A method for providing emotional intelligence insight, said method comprising:
displaying a test on at least one user device within a test platform;
gathering a set of user input from a user taking the test;
transmitting the set of user input to at least one server;
comparing the set of user input to a set of reference data;
generating a report with a result generator; the report reflecting at least the work style and communication preferences of the user; and
enabling a software component to access the report of the user to display information from the report within a communication platform on the at least one user device; the software component comprising at least one analysis button.

26. The method of claim 25, further comprising creating a user profile to maintain the report in an accessible format.

27. The method of claim 26, further comprising engaging with a detailed view action area within a modal on the communication platform to display the user profile.

28. The method of claim 25, further comprising storing the report in the at least one server.

29. The method of claim 25, further comprising engaging with the at least one analysis button to display an individual summary reflecting the report.

30. The method of claim 29, further comprising displaying the individual summary in a detailed manner within the communication platform on a modal.

31. The method of claim 25, further comprising engaging with the at least one analysis button to display a group summary reflecting at least one characteristic from the report of each user in a group.
